(19) United States
(12) Patent Application Publication
(10) Pub. No.: US 2008/0197639 A1
(43) Pub. Date: Aug. 21, 2008

(54) BI-DIRECTIONAL WIND TURBINE

(76) Inventor: Mark Brander, Corunna (CA)

Correspondence Address: BERESKIN AND PARR, 40 KING STREET WEST, BOX 401, TORONTO, ON, M5H 3Y2, omitted

(21) Appl. No.: 11/675,432

(22) Filed: Feb. 15, 2007

(51) Int. Cl. F03D 9/00; F03D 1/02

(52) U.S. Cl. 290/55; 415/124.2; 416/178

(57) ABSTRACT

A wind turbine, having a generator to generate electricity and including a first rotatable power element and a second rotatable power element adapted for contra-rotation relative to one another about a generator axis, a pair of rotors to convert wind energy into rotational energy and generally disposed at a first end of the generator and adapted for rotation about a rotor axis offset from the generator axis, and including a first rotor and a second rotor wherein the first rotor is disposed between the second rotor and the generator, and a transmission to couple the pair of rotors to the generator, and including a first driveshaft coupled to the first rotor, a first drive element coupled to the first driveshaft, a first driven element coupled to the first drive element and to the first rotatable power element of the generator, a second driveshaft coupled to the second rotor and extending through the first driveshaft, a second drive element coupled to the second driveshaft, and a second driven element coupled to the second drive element and to the second rotatable power element of the generator.

### FIELD

The embodiments described herein relate to the field of energy generation, and more particularly to the conversion of wind energy into electrical energy.

### BACKGROUND

Electrical energy can be produced using various methods. A number of these methods, for example burning hydrocarbons or coal, involve the release of harmful greenhouse gases into the atmosphere, which can lead to pollution and have a damaging effect on the environment. Other methods, such as nuclear power, are cleaner but require the use of dangerous materials, such as uranium, that lead to safety concerns and generate hazardous, long-lasting waste products.

True clean methods of generating electricity are available, such as the use of solar cells and wind turbines, with no harmful waste products or safety concerns. However, these methods are not without their limitations. Solar cells face significant efficiency and cost problems and have yet to see mainstream acceptance, while current wind turbine designs face additional challenges.

### SUMMARY

In some embodiments, there is provided a wind turbine, having a generator to generate electricity, and including a first rotatable power element and a second rotatable power element adapted for contra-rotation relative to one another about a generator axis, a pair of rotors to convert wind energy into rotational energy and generally disposed at a first end of the generator and adapted for rotation about a rotor axis offset from the generator axis, and including a first rotor and a second rotor wherein the first rotor is disposed between the second rotor and the generator, and a transmission to couple the pair of rotors to the generator, and including a first driveshaft coupled to the first rotor, a first drive element coupled to the first driveshaft, a first driven element coupled to the first drive element and to the first rotatable power element of the generator, a second driveshaft coupled to the second rotor and extending through the first driveshaft, a second drive element coupled to the second driveshaft, and a second driven element coupled to the second drive element and to the second rotatable power element of the generator.

In some embodiments, there is provided a wind turbine, comprising a pair of rotors to convert wind energy into rotational energy and including a first rotor and a second rotor, wherein the first rotor includes a first end having a first diameter, a first annular array of blades generally disposed at the first end, a second end having a second diameter smaller in size than the first diameter, and a substantially circumferentially continuous web extending between the first and second ends to define a flow surface, and wherein the second rotor includes a second annular array of blades adjacent the first annular array of blades.

In some embodiments, there is provided a wind turbine having a pair of rotors to convert wind energy into rotational energy and including a first rotor and a second rotor adjacent the first rotor, wherein the first rotor includes a first rim carrying a first annular array of blades, a first driveshaft, and a first array of spokes coupled between the first rim and the first driveshaft, and wherein the second rotor includes a second rim carrying a second annular array of blades, a second driveshaft extending through the first driveshaft, and a second array of spokes coupled between the second rim and the second driveshaft.

In some embodiments, there is provided a generating apparatus for generating electrical energy from a wind field having a plurality of airflows, the apparatus having a first plurality of blades for engaging the airflows, the first plurality of blades being configured to rotate in a first angular direction about a first axis of rotation when exposed to the airflows, a second plurality of blades for engaging the airflows, the second plurality of blades being configured to rotate in a second angular direction about a second axis of rotation when exposed to the airflows, the second angular direction being opposite the first angular direction, at least one flow directing surface for directing the airflows i) outward from the first axis of rotation to engage the first plurality of blades, and ii) outward from the second axis of rotation to engage the second plurality of blades, wherein the at least one flow directing surface is configured relative to the first plurality of blades and the second plurality of blades such that during operation i) most of the airflows engaging the first plurality of blades are directed outwards by the at least one flow directing surface, and ii) most of the airflows engaging the second plurality of blades are directed outwards by the at least one flow directing surface, a generator for generating electrical energy having an armature and a stator, and a gear assembly coupled to the first plurality of blades and the second plurality of blades, and configured to drive the armature in a third angular direction and the stator in a fourth angular direction as the first plurality of blades turn in the first angular direction and the second plurality of blades turn in the second angular direction, the fourth angular direction being opposite the third angular direction, wherein, as the armature rotates in the third direction and the stator rotates in the fourth direction, the generator generates electrical energy.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be, reference will now be made, by way of example only, to the accompanying drawings which show at least one exemplary embodiment, and in which:

FIG. 1 is perspective view of a bidirectional wind turbine according to one embodiment;

FIG. 2 is a side elevation view of the wind turbine of FIG. 1;

FIG. 2A is a close up side elevation view of the wind turbine as shown in FIG. 1;

FIG. 3 is an end view of the wind turbine as shown in FIG. 1;

FIG. 4 is partial cross sectional side view of the wind turbine as shown in FIG. 1;

FIG. 4A is a close up partial side view of the generator of the wind turbine as shown in FIG. 1;

FIG. 5 is a perspective view showing the wind turbine of FIG. 1 in operation in a wind field;

FIG. 6 is a side elevation view of a bidirectional wind turbine according to another embodiment;

FIG. 7 is an overhead view of the wind turbine of FIG. 6;

FIG. 8 is a perspective view of a wind turbine according to another embodiment;

FIG. 9 is a partial cross sectional side view of the wind turbine of FIG. 8; and

FIG. 10 is an end view of the wind turbine of FIG. 8.

### DETAILED DESCRIPTION

In describing embodiments of the present invention, as illustrated in the figures and/or described herein, specific terminology is employed for the sake of clarity. The invention, however, is not intended to be limited to the specific terminology so selected, and it is to be understood that each specific element includes all the technical equivalents that operate in a similar manner to accomplish similar functions.

According to some embodiments, a bidirectional wind turbine is provided having contra-rotating rotors that reduce the magnitude of gear ratios needed to efficiently convert wind energy into electrical energy, and which tend to reduce torque stresses induced in the turbine support structure. As a result, the bidirectional turbine can run at higher efficiencies than conventional wind turbines, and tends to be more reliable.

In some embodiments, a bidirectional wind turbine includes a generator for generating electricity including a first rotatable power element, which may include a field element or stator, and a second rotatable power element, which may include an armature or rotor, the second rotatable power element adapted for contra-rotation relative to the first rotatable power element about a generator axis. The wind turbine also includes a pair of rotors to convert wind energy into rotational energy and being generally disposed at a first end of the generator and adapted for rotation about a rotor axis offset from the generator axis, and including a first rotor and a second rotor wherein the first rotor is disposed between the second rotor and the generator. The wind turbine also includes a transmission for coupling the pair of rotors to the generator, including a first driveshaft coupled to the first rotor, a first drive element, such as a first drive gear, coupled to the first driveshaft, a first driven element, such as a first driven gear, coupled to the first drive element and to the first rotatable power element of the generator, and a second driveshaft coupled to the second rotor and extending through the first driveshaft, a second drive element, such as a second drive gear, coupled to the second driveshaft, and a second driven element, such as a second driven gear, coupled to the second drive element and to the second rotatable power element of the generator.

In some embodiments, the generator of the wind turbine includes a first end plate coupled to the first rotatable power element and to the first driven element, a second end plate coupled to the first rotatable power element and carrying commutator rings thereon, a generator shaft coupled to the second rotatable power element and to the second driven member, and extending through the first rotatable power element and the first and second end plates, and a pair of bearings for supporting the generator shaft on opposite ends of the generator.

In some embodiments, the first rotor of the wind turbine includes a first end having a first diameter, a first annular array of blades generally disposed at the first end, and a second end having a second diameter smaller in size than the first diameter.

In some embodiments, the second rotor of the wind turbine includes a first end having a first diameter, a second annular array of blades generally disposed at the first end, and a second end having a second diameter smaller in size than the first diameter.

In some embodiments, the first and second rotors of the wind turbine are generally cone shaped and at least partially nested such that the second end of the second rotor is disposed between the first and second ends of the first rotor.

In some embodiments the second rotor includes a rim having a diameter substantially corresponding to the first diameter of the first rotor, a second annular array of blades generally disposed at the rim, and an array of spokes coupled between the rim and the second driveshaft.

In some embodiments, the first rotor includes a first rim having a first diameter, a first annular array of blades generally disposed at the first rim, a first array of spokes coupled between the first rim and the first driveshaft, and the second rotor includes a second rim having a second diameter, a second annular array of blades generally disposed at the second rim, and a second array of spokes coupled between the second rim and the second drive shaft.

In some embodiments the first rotor includes a first annular array of blades disposed at a first angle and the second rotor includes a second annular array of blades disposed at a second angle different from the first angle. In some embodiments, the first and second angles are opposite in direction to effect contra-rotation of the rotors. In some embodiments, the first and second angles are equal in magnitude.

In some embodiments, the first drive element and first driven element define a first speed ratio between 4:1 and 30:1 and the second drive element and second driven element define a second speed ratio between 4:1 and 30:1.

In some embodiments, the first drive gear and first driven gear are disposed at a first end of the generator and the second drive gear and second driven gear are disposed on an oppositely disposed second end of the generator.

In some embodiments, the wind turbine includes a support structure adapted to carry the generator, and wherein the second driveshaft extends through a portion of the support structure.

In some embodiments, a wind turbine includes a pair of rotors to covert wind energy into rotational energy and including a first rotor and a second rotor, wherein the first rotor includes a first end having a first diameter, a first annular array of blades generally disposed at the first end, a second end having a second diameter smaller in size than the first diameter, and a substantially circumferentially continuous web, which in some embodiments is generally cone-shaped, and extending between the first and second ends to define a flow surface, and wherein the second rotor includes second annular array of blades adjacent the first annular array of blades.

In some embodiments, the second rotor includes a first end supporting the second annular array of blades and having a first diameter and a second end having a second diameter smaller in size that the first diameter, and a second substantially circumferentially continuous web extending between the first and second ends of the second rotor, wherein the second rotor is at least partially nested within the first rotor such that the second end of the second rotor is disposed between the first and second ends of the first rotor.

In some embodiments, a wind turbine includes a pair of rotors to convert wind energy into rotational energy and including a second rotor adjacent the first rotor, wherein the first rotor includes a first rim carrying a first annular array of blades, a first driveshaft and a first array of spokes coupled between the first rim and the first driveshaft, and wherein the second rotor includes a second rim carrying a second annular array of blades, a second driveshaft extending through the first driveshaft, and a second array of spokes coupled between the second rim and the second driveshaft.

In some embodiments, a generating apparatus for generating electrical energy from a wind field having a plurality of airflows, having a first plurality of blades for engaging the airflows and being configured to rotate in a first angular direction about a first axis of rotation when exposed to the airflows, a second plurality of blades for engaging the airflows and being configured to rotate in a second angular direction about a second axis of rotation when exposed to the airflows, the second angular direction being opposite the first angular direction, at least one flow directing surface for directing the airflows outward from the first axis of rotation to engage the first plurality of blades and outward from the second axis of rotation to engage the second plurality of blades, wherein the at least one flow directing surface is configured relative to the first plurality of blades and the second plurality of blades such that during operation, most of the airflows engaging the first plurality of blades are directed outwards by the at least one flow directing surface and most of the airflows engaging the second plurality of blades are directed outwards by the at least one flow directing surface, and a generator for generating electrical energy having an armature and a stator, and a gear assembly coupled to the first plurality of blades and the second plurality of blades and configured to drive the armature in a third angular direction and the stator in a fourth angular direction as the first plurality of blades turn in the first angular direction and the second plurality of blades turn in the second angular direction, the fourth angular direction being opposite the third angular direction, wherein as the armature rotates in the third direction and the stator rotates in the fourth direction, the generator generates electrical energy.

In some embodiments, the at least one flow directing surface of the apparatus comprises a first outer surface of a first rotor linking the first plurality of blades to the gear assembly.

In some embodiment, the apparatus includes a pivotal mount for pivoting the first rotor and the first plurality of blades, wherein the first outer surface of the first rotor is configured to generate, when exposed to the airflows, a drag force for pivoting the first rotor and the first plurality of blades such that the first outer surface of the first rotor is upwind of the first plurality of blades.

In some embodiments, the apparatus includes a second rotor linked the second plurality of blades to the gear assembly, wherein the second rotor is offset from and at least partially nested within the first rotor.

In some embodiments, the second rotor is coupled to the first rotor to pivot with the first rotor.

In some embodiments, the first outer surface has a first frusto-conical shape defined by a first cone angle. In some embodiments, the second rotor has a second frusto-conical shape defined by a second cone angle.

In some embodiments, each blade in the first plurality of blades is offset at a first angle from a first plane, and each blade in the second plurality of blades is offset at a second angle from a second plane, the second angle being in the opposite direction as the first angle, and wherein the first plane and second plane are generally parallel. In some embodiments, the first angle is substantially equal in magnitude to the second angle.

In some embodiments, the gear assembly of the apparatus is coupled to the first rotor and the second rotor by a first shaft and a second shaft, wherein the first shaft is hollow and the second shaft passes through the first shaft.

In some embodiments, the first plurality of blades extend radially from the first rotor and the second plurality of blades extend radially from the second rotor.

In some embodiments, the first plurality of blades is located proximate an end of the first rotor and the second plurality of blades is located proximate an end of the second rotor.

In some embodiments, the pivotal mount includes a support structure for disposing the first rotor and the second rotor and a predetermined distance away from a ground structure, the pivotal mount being operable to facilitate pivoting of the first rotor and the second rotor with respect to the ground surface.

In some embodiments, the bidirectional wind turbine includes a “double cone” rotor configuration, having a cone shaped first rotor and a cone shaped second rotor, the second rotor being offset from, and partially nested within, the first rotor. The first rotor is configured to rotate in a first angular direction when the wind turbine is exposed to a particular wind field, while the second rotor is configured to rotate in a second angular direction opposite the first angular direction when exposed to the same wind field having a plurality of airflows. Thus, during operation, the first rotor and second rotor turn in opposite directions, and convert wind energy into rotational energy.

In some embodiments, the conversion of wind energy into rotational energy is effected by a plurality of blades located on each of the first rotor and second rotor that extend radially outwardly from the large end of the cone shape of each of the first and second rotors. The blades are inclined at a first and second angle with respect to planes orthogonal to the axes of rotation of the first and second rotors. The blades engage the airflows of the wind field as they pass over the rotors, deflecting the moving airflows and causing the first rotor to rotate in the first angular direction and the second rotor to rotate in the second angular direction.

In some embodiments, the first and second rotors are coupled via a transmission, such as a gear assembly, to a generator having an armature and a stator, the generator being configured to convert the rotational energy generated by the first and second rotors into electrical energy. In one embodiment, the first rotor is configured to drive the armature in a third angular direction while the second rotor is configured to drive the stator in a fourth angular direction, the fourth angular direction being opposite the third angular direction. In this manner, the armature and stator are driven in opposite directions about a common axis defined as the generator axis.

During operation, the armature and stator interact magnetically to produce electricity. Unlike other generators, in the present embodiment as both the armature and stator are being driven, each one can be driven at lower rpm while obtaining generator efficiencies that would otherwise only be available in other generators operating at much higher rpm.

The bidirectional turbine can be supported at a distance from a ground surface by a support structure configured to allow the entire turbine assembly to pivot with respect to the ground surface. In this manner, pressure caused by the airflows of the wind field acting against the outer surface of the first rotor tends to cause the turbine to orient itself to acquire an improved operating direction, regardless of the direction of the airflows in the wind field.

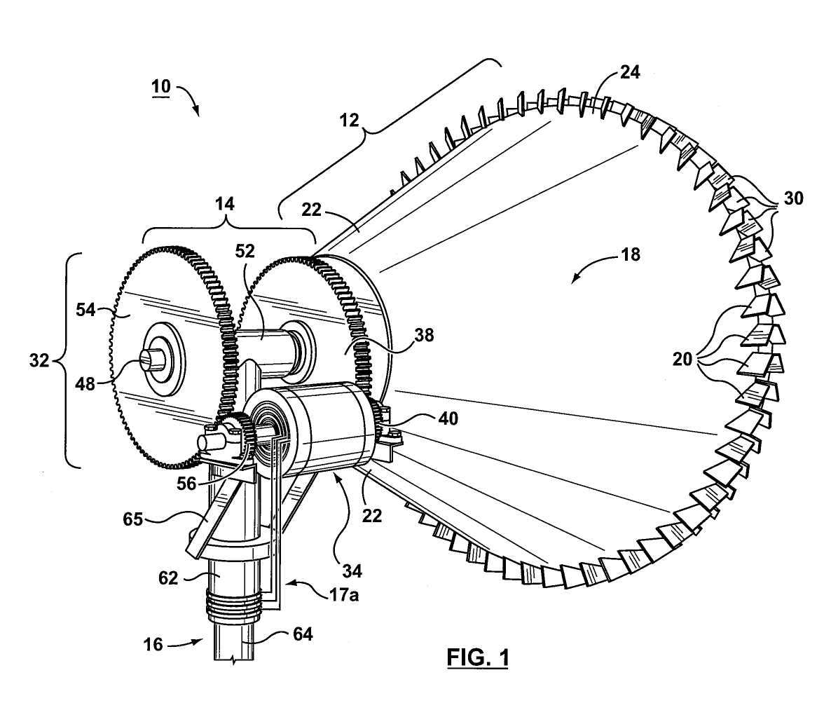

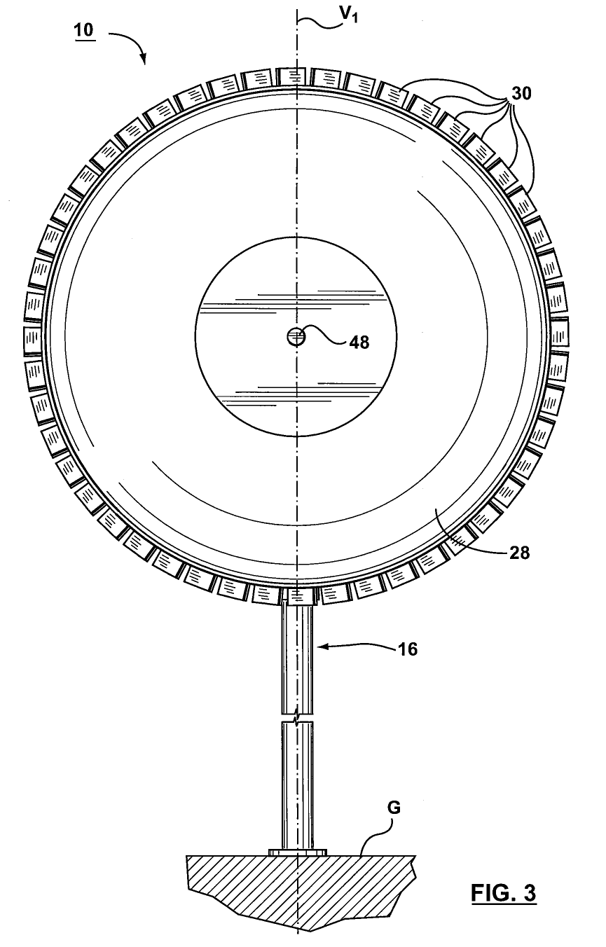

With reference now to FIGS. 1 through 4A, a bidirectional wind turbine 10 according to one embodiment is shown. The turbine 10 includes a first energy conversion portion 12 and a second energy conversion portion 14, supported by a support structure 16. The first energy conversion portion 12 is configured to convert wind energy into rotational energy, while the second energy conversion portion 14 is configured to convert the rotational energy generated by the first energy conversion portion 12 into electrical energy.

The support structure 16 supports the first energy conversion portion 12 and the second energy conversion portion 14 at a predetermined distance away from a ground surface G to allow the first energy conversion portion 12 to experience desired wind conditions. The support structure 16 is also configured to allow the first energy conversion portion 12 and second energy conversion portion 14 to pivot about a vertical axis V₁ substantially normal to the ground surface G, so that the first energy conversion portion 12 can remain oriented at a desired angle with respect to any particular wind field to maintain improved operating conditions.

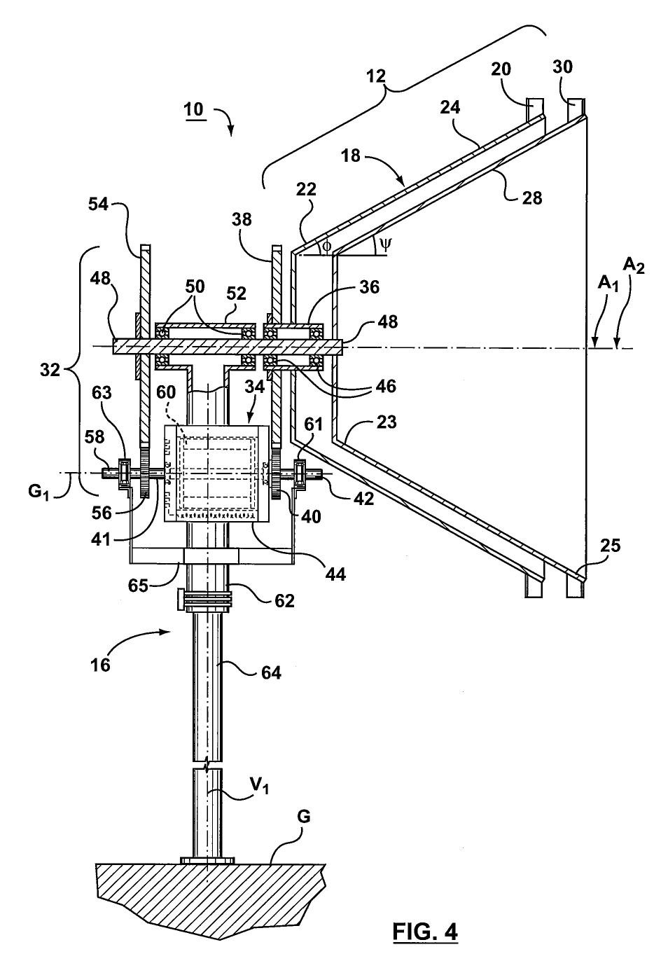

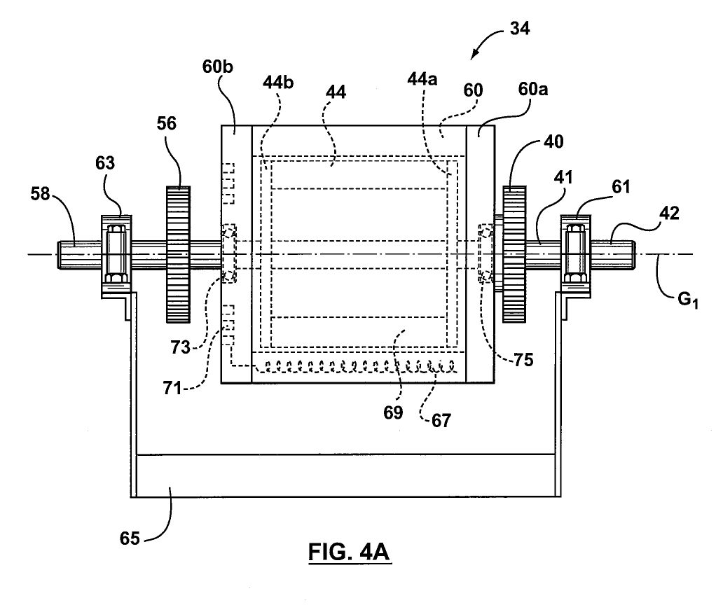

In some embodiments, the first energy conversion portion 12 includes a first rotor 18 having a generally frusto-conical shape and being configured to rotate about a first axis of rotation A₁ in a first angular direction when exposed to a wind field. The first energy conversion portion 12 also includes second rotor 28, also having a frusto-conical shape, and being slightly offset from, and partially nested within, the first rotor 18, as best shown in FIG. 4. The second rotor 28 is configured to rotate about a second axis of rotation A₂ in a second angular direction, the second angular direction being opposite the first angular direction, when exposed to the same wind field. Thus, during operation within a particular wind field the first rotor 18 and second rotor 28 will tend to rotate in opposite directions.

In this embodiment, as best shown in FIG. 4, the first axis of rotation A₁ and second axis of rotation A₂ are coincident or coaxial. In such embodiments, the first axis of rotation A₁ and second axis of rotation A₂ can be defined as a single axis called a rotor axis.

In other embodiments, the first axis of rotation A₁ and second axis of rotation A₂ need not be coincident, and it may be possible to have various, non-planar axes of rotation in different embodiments. To reduce unwanted drag forces, in some embodiments the first axis of rotation A₁ and second axis of rotation A₂ are often parallel.

In some embodiments, it is desirable in order to reduce unwanted drag forces and improve operating efficiency that the first axis of rotation A₁ and second axis of rotation A₂ be generally parallel to the direction of the airflows of the prevailing wind in a particular wind field. As the airflows in many wind fields proximate a ground surface tend to travel parallel to the ground surface G, first rotor 18 and second rotor 28 in some embodiments can be configured such that the first axis of rotation A₁ and the second axis of rotation A₂ are parallel to the ground surface G.

In some embodiments, the pressure drag acting on the outer surface of the first rotor 18 will tend to align the first and second axes of rotation A₁, A₂ of the first rotor 18 and second rotor 28 with the prevailing wind direction, tending to improve operating efficiency.

The generally frusto-conical shape of the first rotor 18 is defined by a leading end 22 of the first rotor 18 being of a smaller diameter, and a trailing end 24 of the first rotor 18 being of a larger diameter. As described above, the pressure drag acting on the outer surface of the first rotor 18 will tend to pivot the first rotor 18 and the second rotor 28 such that the leading end 22 of the first rotor 18 is closer to the direction from which the wind is traveling, or “upwind”, while the trailing end 24 is closer to the direction in which the wind is heading, or “downwind”.

In some embodiments, the outer surface of the first rotor is defined by a substantially circumferentially continuous web extending between the leading end 22 and the trailing end 24 of the first rotor 18 to define a flow directing surface. The flow directing surface directs airflows within the wind field outward from the first axis of rotation A₁ to engage a first plurality, or array, of blades 20, and outward from the second axis of rotation A₂ to engage a second plurality, or array, of blades 30, and the flow directing surface is configured relative to the first plurality of blades 20 and the second plurality of blades 30 such that during operation most of the airflows engaging the first plurality of blades 20 are directed outwards by the flow directing surface, and most of the airflows engaging the second plurality of blades 30 are directed outwards by the flow directing surface.

The frusto-conical shape of the first rotor 18 can be described by reference to a first cone angle φ, which can be defined as the angle of inclination of the surface of the first rotor 18 from the leading end 22 to the trailing end 24 with respect to the first axis of rotation A₁, as best shown in FIG. 4.

In some embodiments, the second rotor 28 is also of a similar frusto-conical shape and size to the first rotor 18, with a leading end 23, a trailing end 25, and a similarly defined second cone angle ψ, as best shown in FIG. 4.

In some embodiments the first rotor 18 and second rotor 28 are at least partially nested such that the leading end 23 of the second rotor 28 is disposed between the leading end 22 and trailing end 24 of the first rotor 18.

In some embodiments, the diameter of the leading end 22 of the first rotor 18 is smaller in size than the diameter of the trailing end 24 of the first rotor. In some embodiments, the diameter of the leading end 23 of the second rotor 28 is smaller in size than the trailing end 24 of the second rotor 28.

The first cone angle φ and second cone angle ψ can be selected according to the needs of a particular application, or the characteristics of a particular wind field. It will be generally understood that as the first cone angle φ is increased, a greater pressure drag will be experienced by the first rotor 18, within the airflows of any particular wind field. A greater pressure drag may be desirable in some situations, particularly in swirling wind conditions, as it will assist in more quickly rotating the turbine 10 in order to be properly oriented within a particular wind field, even at lower wind speeds. In some embodiments, the first cone angle φ is 30°. In other embodiments, the first cone angle φ is 45°. In some embodiments, the first cone angle φ and the second cone angle ψ are equal, while in other embodiments the first cone angle φ and the second cone angle ψ are not equal.

In some embodiments, a larger first cone angle φ may be desirable as it may assist in forcing the airflows of a particular wind field outward and away from the first plurality of blades 20 and second plurality of blades 30, which may assist in preventing damage to the first rotor 18 and second rotor 28 when the wind velocities are excessively high, preventing over-revving of the first rotor 18 and second rotor 28.

In some embodiments, excessive wind speeds would be much less than hurricane force winds. In other embodiments, excessive wind speeds would be based on the particulars of a transmission and generator rated speed. For example, in some embodiments, the first rotor 18 and second rotor 28 should be rotating between one-half and one-quarter of the rated speed of the generator.

In some embodiments, a larger first cone angle φ and second cone angle ψ may be desirable to provide additional rigidity to the structure of the first rotor 18 and second rotor 28.

The first rotor 18 and second rotor 28 can be built of any suitably light but strong material. In some embodiments, the first rotor 18 and second rotor 28 could be built as a structure of interconnected tubing and then covered with a metallic or fabric skin. In other embodiments, the first and second rotors 18, 28 can be made of plastic or other suitable synthetic materials, for example utilizing an injection-molding process or a rotational casting process. The first rotor 18 and second rotor 28 can also be made of stamped metal sections that are joined in some manner, for example by bolting, riveting or welding. In still other embodiments, the first rotor 18 and second rotor 28 can be made of suitable composite materials, such as carbon fiber or Kevlar.

In some embodiments, the second rotor 28 may have a substantially circumferentially continuous web extending between the leading end 23 and the trailing end 25 to define a flow directing surface.

In some embodiments, wherein the second rotor 28 is partially nested within the first rotor 18, the second rotor 28 may have a plurality of “cut out” sections of the cone surface such that it does not have a substantially circumferentially continuous web extending between the leading end 23 and the trailing end 25.

In some embodiments, the first rotor 18 and second rotor 28 could be build using interconnected tubing wherein the first rotor 18 has a metallic or fabric skin covering it, while the second rotor 28 would have no such skin.

As discussed above, the first rotor 18 and second rotor 28 operate to convert wind energy from a wind field into rotational energy which is then provided to the second energy conversion portion 14, as discussed in further detail below, in order to generate electricity.

The conversion from wind energy to rotational energy relies on structural elements, or blades, on the first rotor 18 and second rotor 28 that cause rotation of the rotors 18, 28 when they are exposed to a wind field. In the embodiment as shown, the first rotor 18 and second rotor 28 comprise a first plurality of blades 20 and a second plurality of blades 30, respectively, that convert the wind energy of the wind field into the torque necessary to cause the first and second rotors 18, 28 to rotate.

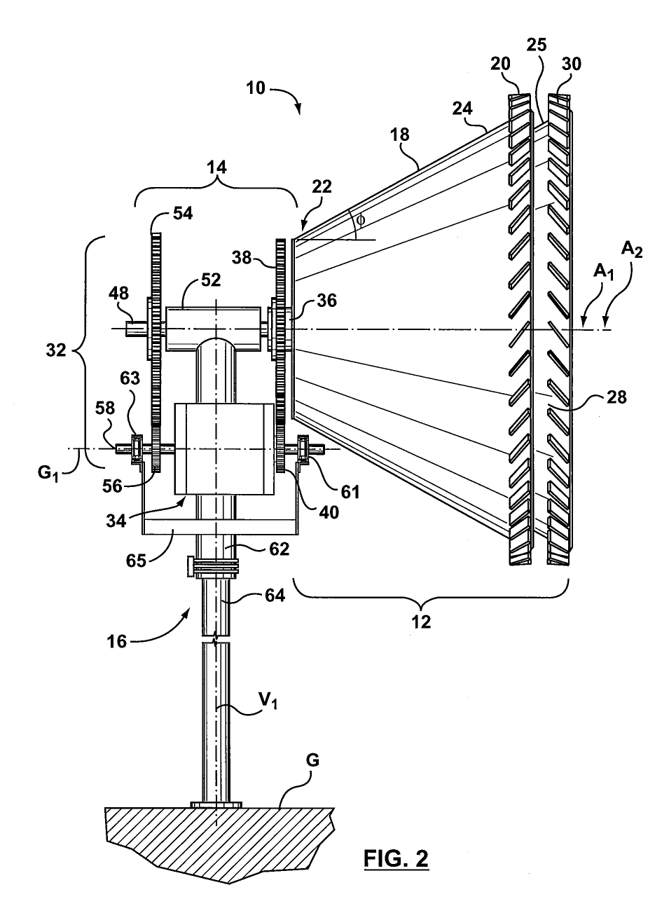

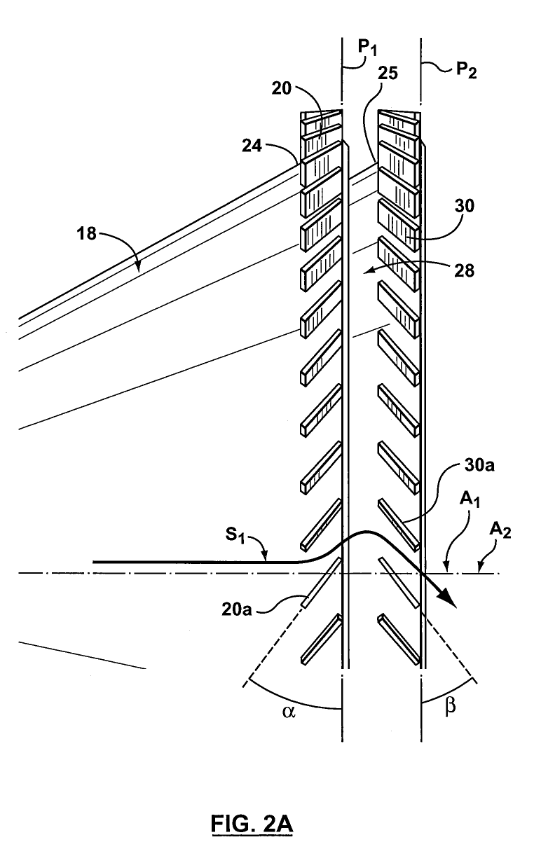

In some embodiments, the first plurality of blades 20 extend radially from the trailing end 24 of the first rotor 18. As best shown in FIG. 2A, the blades 20 are oriented at a first blade angle α with respect to a first plane P₁. First plane P₁ is orthogonal to the first axis of rotation A₁, and is located proximate the trailing end 24 of the first rotor 18.

During operation, airflows flowing along the outer surface of the first rotor 18 can strike the first plurality of blades 20, to be deflected by the blades 20, as shown by an exemplary airflow streamline S₁ striking a particular blade 20a. By operation of Newton's second law, this deflection will cause the first rotor 18 to rotate in the first direction opposite the direction of the deflected airflow streamline S₁.

Similarly, the second plurality of blades 30 extend radially from the second trailing end 25 of the second rotor 28, and are offset at a second blade angle β from a second plane P₂. P₂ is orthogonal to the second axis of rotation A₂, and is located proximate the second trailing end 25 of the second rotor 28. The second blade angle β is generally of opposite orientation to the first blade angle α, such that air flowing over the second rotor 28 will be deflected in the opposite direction and cause the second rotor 28 to rotate in the second angular direction, as shown by streamline S₁ striking a particular second blade 30a. Thus, airflows moving over the outer surface of the first rotor 18 will engage the respective blades 20, 30 and cause the first rotor 18 and second rotor 28 to rotate in opposite directions.

As shown in this embodiment, the blades 20, 30 are impeller or “drag-type” blades, and rely on drag forces generated as air strikes the surface of the blades to cause rotation of the first and second rotors 18, 28. In other embodiments, the blades 20, 30 could be propeller or “lift type” blades, and rely on lift generated by air moving smoothly over the surfaces of the blades to generate the torque needed to cause the first and second rotors 18, 28 to rotate.

The blades 20, 30 can be fashioned out of any number of materials having sufficient strength and durability, and can be manufactured via any number of processes. For example, in some embodiments, the blades 20, 30 can be made of plastic via an injection molding or rotational casting process. In other embodiments, the blades 20, 30 can be made of a metal, such as steel, via a stamping process. In some embodiments, the blades 20, 30 can be individual pieces separate from the main body of the first and second rotors 18, 28, and can be made of different materials than the rotors 18, 28. In other embodiments, the blades 20, 30 can be integrally formed with the rotors 18, 28.

In some embodiments, the blades 20, 30 may be of a simple, flat plate design. In other embodiments, the blades 20, 30 may have a curved shape or a complex aerofoil cross-section designed to increase aerodynamic efficiency and decrease air turbulence generated as air passes over the blades 20, 30.

In some embodiments, a combination of impeller type blades and lift type blades can be used in blades 20, 30. For example, the first plurality of blades 20 may include lift type blades while the second plurality of blades 30 includes drag type blades. In some embodiments, some of the blades in the first and second plurality of blades 20, 30 can be curved while other blades in the first and second plurality of blades 20, 30 can be flat.

In some embodiments, the blades 20, 30 can be coupled to the first and second rotors 18, 28 via a spilling mechanism (not shown) that will allow the blades 20, 30 to spill excess wind during high wind conditions by allowing the blades to deflect. This feature operates as a safety feature, and helps resist over-revving of the first and second rotors 18, 28 in excessive wind speeds, which could cause damaging mechanical stresses. In some embodiments, the spilling mechanism would operate to begin spilling wind at wind velocities of 25 mph and greater.

In some embodiments, the spilling mechanism could include rubber mounts positioned between the blades 20, 30 and the first and second rotors 18, 28. In other embodiments, metal springs could be used to secure the blades 20, 30 to the rotors 18, 28. These metal springs could be made of a sufficiently pliable material to deflect under excessive wind loading. In yet other embodiments, the blades 20, 30 could themselves be made of a sufficiently pliable material that would allow the blades 20, 30 to bend when exposed to excessive wind pressure.

In some embodiments, the first rotor 18 and second rotor 28 are of substantially the same shape, weight and configuration. In other embodiments, the first rotor 18 and second rotor 28 can be of different sizes, shapes, weights and configurations, according to the needs of a particular application. In some embodiments, the first rotor 18 and second rotor 28 can be sized and shaped according to the amount of wind energy each rotor 18, 28 is able to extract from a particular wind field. Thus, if the second rotor 28 is only able to extract a lesser amount of wind energy, it could be made lighter so that it rotates at a higher speed. In other embodiments, the blades 30 of the second rotor 28 could be slightly larger to account for slower air speeds that may result as the air is slowed by interaction with the blades 20 of the first rotor 18.

As discussed above, the first rotor 18 and second rotor 28 are coupled to the second energy conversion portion 14 to convert the rotational energy generated into electrical energy. The second energy conversion portion 14 includes generally a transmission 32, such as a gear assembly, and a generator 34. In some embodiments, the first rotor 18 and second rotor 28 are generally disposed at a first end of the generator 34 and are mounted for rotation about the rotor axis which is offset from a generator axis G₁.

As best shown in FIG. 4, the first rotor 18 and second rotor 28 are coupled to contra-rotating shafts that drive the transmission 32 to turn the respective parts of the generator 34, including a first rotatable power element, such as a field element or stator 60 and a second rotatable power element, such as an rotor or armature 44. The first rotatable power element and second rotatable power element are adapted for contra-rotation relative to one another about the generator axis G₁, as shown in FIGS. 2 and 4.

In some embodiments the transmission 32 comprises a gear assembly. In other embodiments, the transmission 32 comprises a belt drive, chain drive, continuously variable transmission, or other suitably configured transmission device.

In some embodiments, the first rotor 18 is rigidly coupled to and drives a first main shaft 36, which is hollow and is supported by a first bearing 46. The first rotor 18 can be coupled to the first main drive shaft 36 using any suitable fastening device, such as by welding, use of a spline, or by the use of fasteners, such as bolts.

The first main shaft 36 is rigidly coupled to a first drive element, such as a first drive gear 38. Thus, as the first rotor 18 turns in the first angular direction, so turns the first main shaft 36 and the first drive gear 38. The first drive gear 38 is engaged with a first driven element, such as a first driven gear 40, which turns in the opposite direction as the first drive gear 38.

As best shown in FIG. 4A, the first driven gear 40 is rigidly coupled to the stator 60 of the generator 34. Thus, as the first rotor 18 turns in the first angular direction, it drives the stator 60 in a third angular direction. In this embodiment, the third angular direction is equal to the second angular direction, and is opposite the first angular direction.

Similarly, the second rotor 28 is rigidly coupled to and drives a second main shaft 48, which passes through the hollow first main shaft 36, through the first bearing 46 and through a second bearing 50 within a support housing 52. The second main shaft 48 is rigidly coupled to a second drive element, such as a second drive gear 54. Thus, as the second rotor 28 turns in the second angular direction, it drives the second drive gear 54 in the same direction. The second drive gear 54 is engaged to a second driven element, such as a second drive gear 56 that turns in the opposite direction as the second drive gear 54. The second driven gear 56 is rigidly coupled to a generator shaft 41 having a first end 42 and a second end 58. The generator shaft 41 in turn is rigidly coupled to the rotor 44 of the generator 34, the rotor 44 being located within the stator 60. Thus, as the second rotor 28 turns in the second angular direction, the rotor 44 is driven in a fourth angular direction. In this embodiment, the fourth angular direction is equal to the first angular direction, and is opposite the second angular direction.

In some embodiments, the first drive gear 38 and first driven gear 40 are disposed at a first end of the generator 34 and the second drive gear 54 and second driven gear 56 are disposed on an oppositely disposed second end of the generator 34.

It will be appreciated that, in other embodiments, the fourth angular direction may be equal to the second angular direction and the third angular direction may be equal to the first angular direction, according to the particular configuration of the transmission 32. Alternatively, the first, second, third and fourth angular directions may all be different. In some embodiments, different types of gears, such as a worm gear, could be used to allow the generator 34 to be mounted such that the armature 44 and stator 60 rotate about axes that are not parallel to the first and second axes of rotation A₁, A₂.

As best shown in FIG. 4A, the generator shaft 41 passes through both the armature 44 and stator 60, as well as the first driven gear 40, and is supported at the first end 42 by a third bearing 61 and at the second end 58 by a fourth bearing 63. The third bearing 61 and fourth bearing 63 are secured to, and supported by, a bracket portion 65 of the support structure 16.

The armature 44 generally includes a first end plate 44a and a second end plate 44b, and also includes at least one magnet portion 69.

The stator 60 generally includes a first end plate 60a and a second end plate 60b, the second end plate 60b carrying a plurality of commutator rings 71 that engage with brushes (not shown) and are used to carry current flow from the generator 34 to wires 17a (as best shown in FIG. 1) used to carry the current flow to its desired destination, such as a battery. The first end plate 60a and second end plate 60b are supported by, and rotatable about, the generator shaft 41 via bearings 73, 75. The stator 60 also includes at least one induction winding 67. The commutator rings 71 can be configured to provide, for example, single phase AC power, or three phase AC power. In other embodiments, DC power can be generated using modified stator 60 and armature 44 configurations.

The generator shaft 41 also passes through the end plates 60a, 60b of the stator 60, and is secured to the end plates 44a, 44b of the armature 44.

The first large gear 38, first small gear 40, second large gear 54 and second small gear 56 are sized and configured according to the needs of a particular application or according to the characteristics of a particular wind field. In some embodiments, the first large gear 38 and first small gear 40 have a ratio of teeth of 40:1 to define a first speed ratio of 40:1, such that for every single rotation of the first rotor 18, the stator 60 will undergo forty revolutions. In other embodiments, the first large gear 38 and small gear 40 define the first speed ratio at 3:1. In other embodiments, the first speed ratio is between 3:1 and 40:1. In some embodiments, the second large gear 54 and second small gear 56 define a second speed ratio ranging between 3:1 to 40:1. In some embodiments, the first speed ratio is 6:1 and the second speed ratio is 6:1.

It will therefore be understood that, as the first rotor 18 and second rotor 28 rotate in opposite directions, so also do the armature 44 and the stator 60. Specifically, in some embodiments, the stator 60 will be driven in a first angular direction at a first angular velocity ω₁, while the armature 44 is driven in the opposite angular direction at a second angular velocity ω₂. The magnetic interaction of rotating at least one magnetic portion 69 of the armature 44 and rotating at least one induction winding 67 of the stator 60 generates electricity. As the stator 60 and armature 44 are rotating in opposite directions, the generator 34 achieves performance characteristics comparable to a conventional generator having a fixed stator with a rotor being driven at a rotational speed of ω₁+ω₂. In this manner, the overall performance of the generator 34 can be increased while using lower gear ratios in a gear assembly of the transmission 32.

It will be appreciated by those skilled in the art that while ball bearing are shown in FIG. 4, the various shafts can be supported by using any suitable bearing or bushing elements, for example roller bearings, oil-impregnated brass bushings, and plastic or graphite bushings. In embodiments using large sized components operating at very low rpm, it may be possible to use shafts that do not require bearings or bushings. For example, sections of pipe could be used in place of shafts, using a smaller pipe having an outer diameter equal to the inner diameter of a larger pipe, and where the smaller pipe is nested in the larger pipe. In such embodiments, it may be desirable to use dissimilar metals at any contact surfaces to reduce frictional forces, for example by using a plain carbon steel surface against a stainless steel surface. In other embodiments, it may be desirable to use a steel surface against a plastic or synthetic surface to reduce frictional forces.

It will also be appreciated by those skilled in the art that, in some embodiments, the first and second rotors 18, 28 can be coupled to and drive the generator 34 via other suitable transmission mechanisms, such as gear belts, sprockets and chains, or pulleys and belts.

As discussed above, the support structure 16 supports the first energy conversion portion 12 and second energy conversion portion 14 at a distance away from a ground surface. This is done to facilitate placing the turbine 10 in desirable wind conditions, as the airflows in wind fields tend to become more turbulent the closer they are to the ground surface G, and thus become less effective for driving the wind turbine 10. As shown in FIGS. 1-4, the support structure 16 includes the support housing 52, connected to a first vertical member 62 and a second vertical member 64 to space the first energy conversion portion 12 from the ground surface by a predetermined distance. This predetermined distance can be selected according to the needs of a particular application or the wind conditions at a particular location.

The first vertical member 62 and second vertical member 64 can be configured to pivot with respect to each other about the vertical axis V₁, to tend to allow the entire turbine 10 to pivot to adopt a suitable orientation in varying wind conditions. In some embodiments, the first vertical member 62 and second vertical member 64 may be made of tubes, coupled via a bearing or bushing (not shown) to allow the first vertical member 62 to pivot about the second vertical member 64, while the second vertical member 64 remains fixed to the ground surface. In some embodiments, the pivoting may be effected towards the top of the turbine structure to inhibit binding during pivoting. In some embodiments, the pivoting can be accomplished by a turntable design that fits over the main tubular structure.

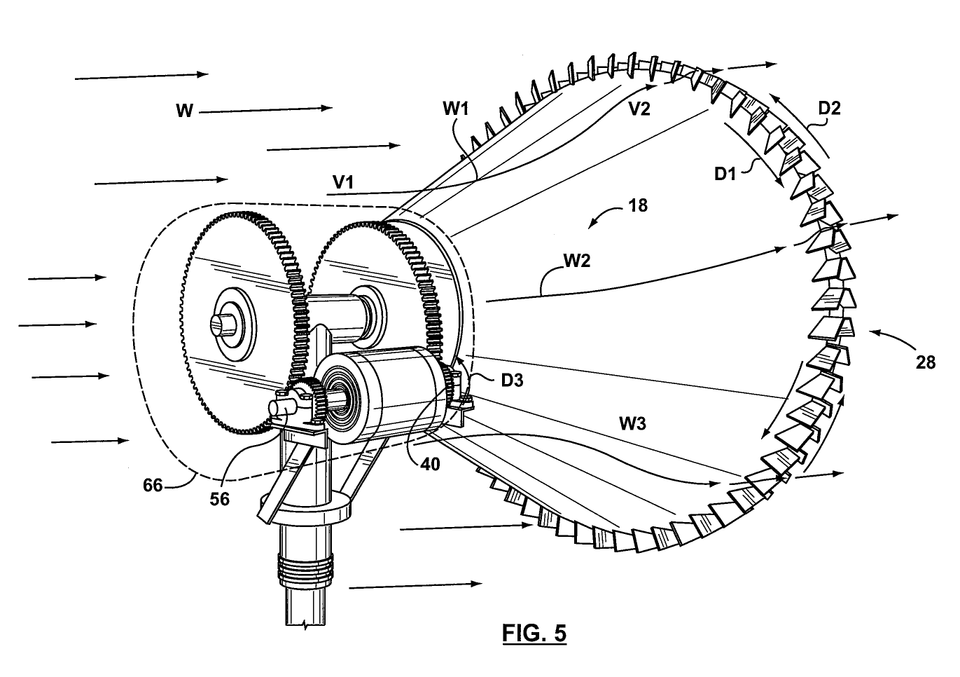

Turning now to FIG. 5, the turbine 10 is shown operating within a wind field W. As shown, at a distance from the turbine 10, the airflows of the wind field W are moving in a generally undisturbed manner, as shown by the airflow streamlines running parallel. As the airflows of the wind field W encounter the flow diverging outer surface of the first rotor 18, the airflows are deflected from their normal path, as shown by exemplary airflow streamlines W1, W2 and W3. This deflection of the airflows has two major effects.

First, it results in pressure drag acting on the surface of the first rotor 18. This pressure drag tends to cause the entire turbine 10 to pivot about the vertical axis V₁ so that the trailing end 24 of the first rotor 18 is downwind from the leading end 22, and the axes of rotation A₁, A₂ of the first rotor 18 and second rotor 28 become aligned with the direction of airflows in the wind field W. In this manner, the turbine 10 tends to reorient itself to adopt a suitable operating orientation in changing wind conditions.

Second, the deflection of the airflows tends to increase the overall efficiency of the turbine 10. As airflows in the wind field W encounter the leading end 22 of the first rotor 28, just prior to any deflection, they are moving at first velocity V₁ generally parallel to the first axis of rotation A₁ of the first rotor 18. Airflows passing beyond the leading end 22 toward the trailing end 24 are deflected by the flow diverging surface (along the cone angle φ of the first rotor 18) as the airflows move over the flow diverging surface towards the blades 20 of the first rotor 18. As the airflows are deflected, they can accelerate. Thus, when the airflows reach the blades 20, the airflows can be moving at a second velocity of V₂, where V₂>V₁.

In this manner, most of the airflows that engage the first plurality of blades 20 and the second plurality of blades 30 have been directed outwards by the flow directing surface of the first rotor 18. The airflows will therefore be concentrated and directed out towards the trailing ends 24, 25 of the first rotor 18 and second rotor 28, where they will engage with the blades 20, 30 of the first rotor 18 and second rotor 28 at an increased distance away from the axes of rotation A₁, A₂ of the first and second rotors 18, 28, tending to generate higher amounts of torque, turning the first rotor 18 in a first direction D₁, and the second rotor 28 in a second direction D₂. Furthermore, as discussed above, this contra-rotating action will cause the first small gear 40 to rotate in a third direction D₃ driving the stator 60, and the second small gear 56 to rotate in a fourth direction D₄, driving the armature 44. In this embodiment, D₁ is equal to D₄, and D₂ is equal to D₃

It will be appreciated that airflows within the wind field W that interact with the transmission 32 before engaging the flow directing surface may become turbulent, which may not be desirable as the turbine 10 tends to work more efficiently when the wind field W provides laminar flow over the flow directing surface towards the blades 20, 30. Thus, in some embodiments, all or a portion of the transmission 32 and generator 34 can be enclosed within a smooth cowl 66 (shown in dashed lines for clarity) to inhibit the formation of turbulent flow within the wind field W.

The use of conical shaped first and second rotors 18, 28 also tends to provide the advantage of expanding the range of wind speeds that will allow for rotor start up. By deflecting the flow lines and increasing the wind speed of the air striking the blades 20, 30, the first rotor 18 and second rotor 28 tend to begin turning in slower wind conditions

A further effect of the second rotor 28 being partially nested within the first rotor 18 is to tend to impart a gyroscopic effect to the turbine 10 that helps to stabilize the turbine 10 as the first rotor 18 and second rotor 28 rotate in opposite directions. This gyroscopic effect assists in countering the effects of shifting wind directions and gusts.

As the first rotor 18 and second rotor 28, in some embodiments, are of similar shape and size, and rotate at similar angular velocities (albeit in opposite directions), one additional benefit is that the net torque felt by the turbine 10 is greatly reduced, minimizing the unbalanced torque loads that tend to be imposed upon the support structure 16, and reducing the chances of overstressing any of the elements of the support structure 16 and leading to a failure condition.

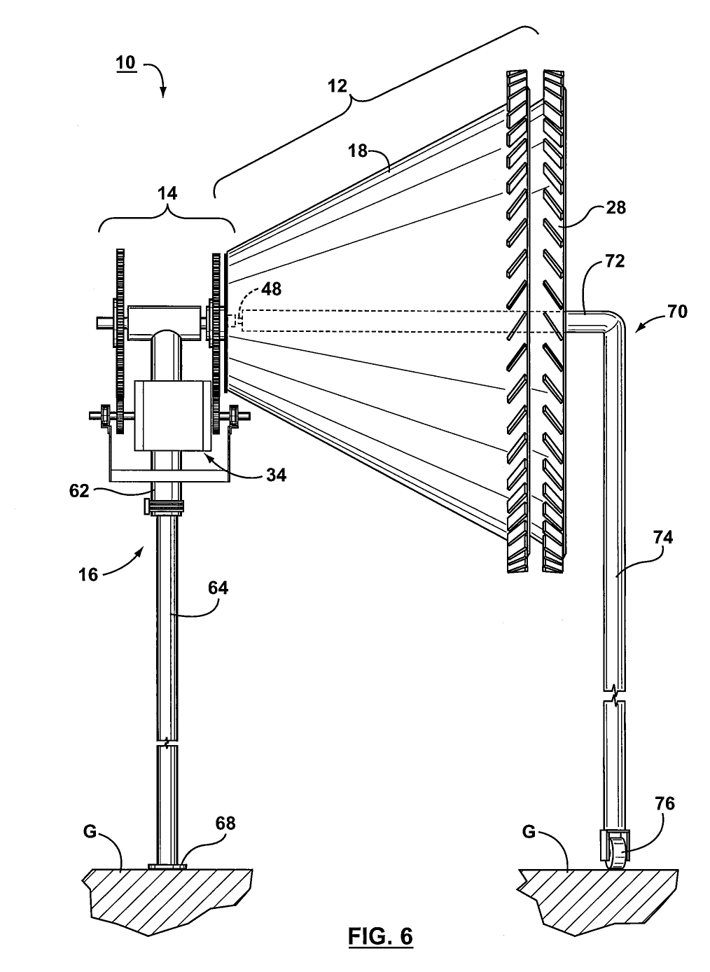

Turning now to FIG. 6, the turbine 10 is shown according to an alternative embodiment having a stabilizer leg 70 attached. The turbine 10 includes the first energy generation portion 12 and the second energy generation portion 14, as discussed in detail above. In this embodiment, the second vertical member 64 is secured to a ground surface G using a flange member 68, which can be bolted or otherwise secured to the ground surface G.

The stabilizer leg 70 is generally L-shaped, and includes an upper horizontal member 72 that is rotabably coupled to the first main shaft 48 within the opening of the second rotor 28, such as via a bearing or bushing (not shown), and a lower vertical member 74 supported on the ground surface G via a wheel 76 or caster. The stabilizer leg 70 can contribute substantially to the ruggedness of the turbine 10, particularly when the turbine 10 is made quite large or experiences very high wind speeds. Pressure forces exerted by airflows in a wind field, such as wind field W, or caused by the eccentric weight of the first and second rotors 18, 28, that would typically introduce bending moments within the first and second vertical members 62, 64 of the support structure are inhibited by supporting the first and second rotors 18, 28 using the stabilizer leg 70. By providing two support points between the turbine 10 and the ground surface G, the entire apparatus can be made more stable.

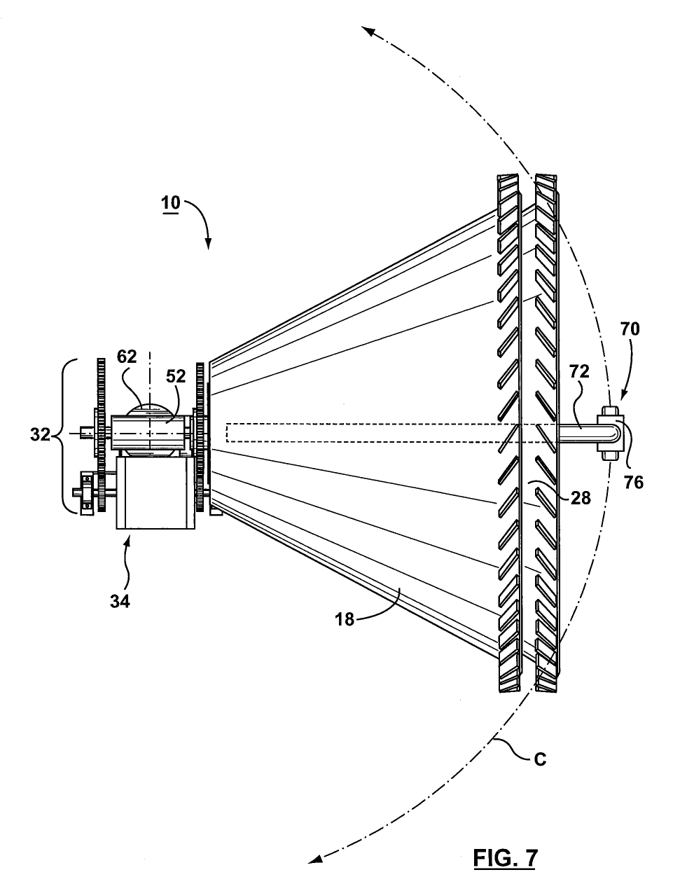

As shown in FIG. 7, the use of the stabilizer leg 70 does not greatly impede the pivoting of the turbine 10 to reorient the turbine 10 in changing wind conditions. The wheel 76 on the lower end of the lower vertical member 74 allows the entire stabilizer leg 70 to pivot along with the turbine 10 by rolling the wheel 76 along the ground surface G in an arc, such as arc C. In some embodiments, the ground surface G should be as level as possible to allow the wheel 76 to track smoothly as the turbine pivots. In some embodiments, the rolling of the wheel 76 could be assisted by a guide-rail affixed to the ground surface G that would provide for even smoother pivoting. In other embodiments, particularly where the ground surface G is uneven, the vertical member 74 could include a spring portion (not shown) to allow the vertical member 74 to telescope and adjust to changing ground heights as the wheel 76 travels along the arc C, to avoid imparting undue stresses to the turbine 10.

In some embodiments, the stabilizer leg 70 can be permanently affixed to the turbine 10. In other embodiments, the stabilizer leg 70 can be a removable attachment. In some embodiments, the stabilizer leg 70 can be constructed of tubing and have a fabric or metal tail or wind guide affixed thereto that that will track with the changing wind direction and assist in keeping the turbine 10 properly aligned with the direction of the wind flow in the wind field.

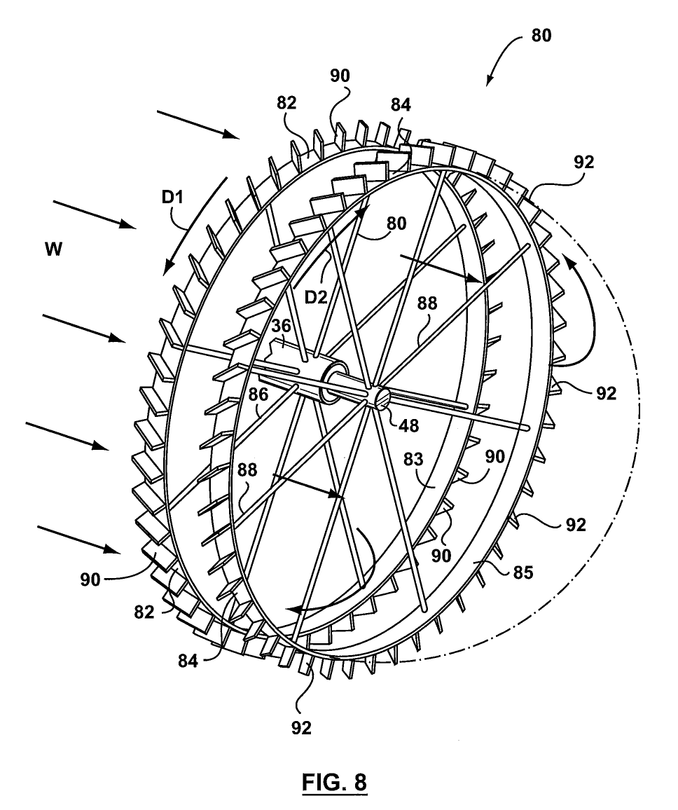

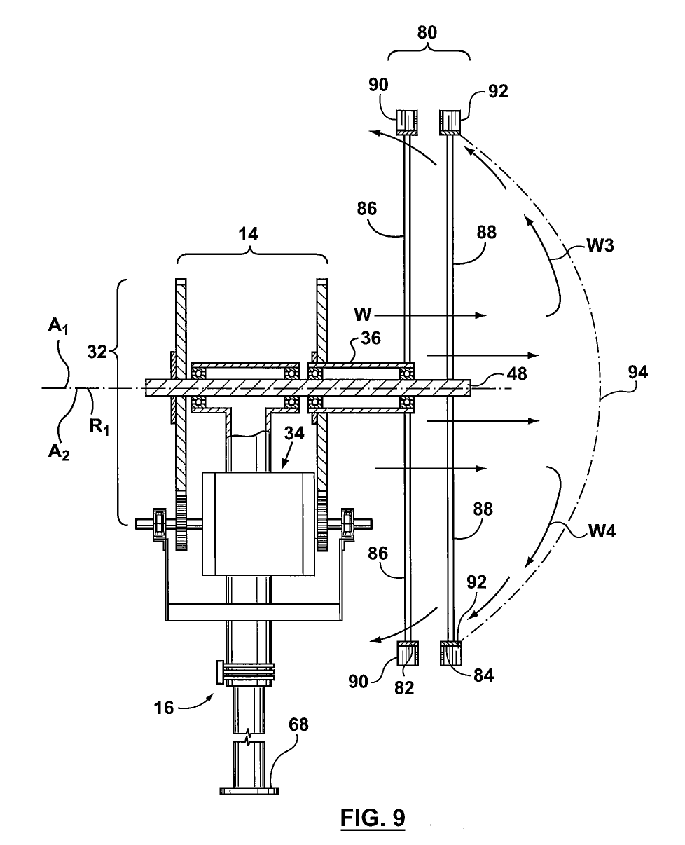

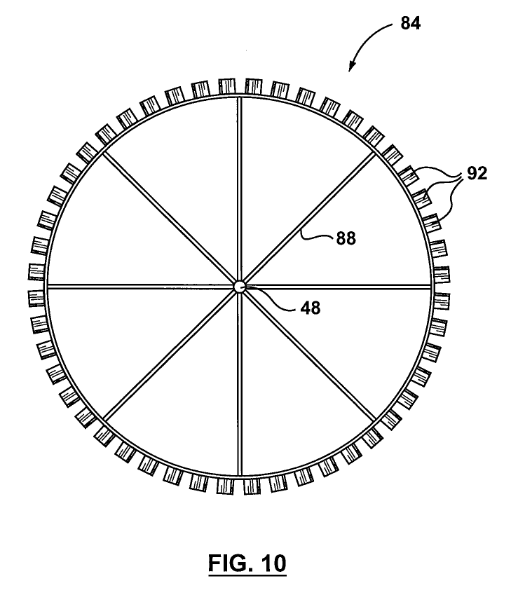

Turning now to FIGS. 8-10, a first energy conversion portion 80 of a turbine 10 according to another embodiment is shown. This first energy conversion portion 80 is also configured to convert wind energy into rotational energy, and could be coupled with the second energy conversion portion 14 and the support structure 16 described above, as shown in FIG. 9. For brevity, the description of FIGS. 1-4 is not repeated relative to FIGS. 8-10.

This first energy conversion portion 80 includes a first rotor 82 and a second rotor 84, the first rotor 82 comprising an annular first rim 83 supported by first spokes 86 and the second rotor 84 comprising an annular second rim 85 supported by second spokes 88. In some embodiments, the diameter of the second rim 85 substantially corresponds to the diameter of the first rotor 82.

The first spokes 86 and second spokes 88 radiate inwards from the first rim 83 and second rim 85, respectively, towards the first and second axes of rotation A₁, A₂ of the first and second rotors 82, 84. The spokes 86 of the first rotor 82 are coupled between the first rim and the first main shaft 36 of the second energy conversion portion 14, while the spokes 88 of the second rotor 84 are coupled between the second rim 85 and the second main shaft 48, and the second main shaft 48 extends through the first main shaft 36. It will be appreciated that in some embodiments, the spokes 86, 88 can be permanently affixed to the first and second main shafts 36, 48, while in other embodiments the spokes 86, 88 can be removable to provide for maintenance or repair.

The first rotor 82 and second rotor 84 include a number of blades 90, 92 for causing contra-rotation of the first rotor 82 and second rotor 84 about a common rotor axis R₁.

In some embodiments, as shown in FIG. 8, the blades 90, 92 extend radially outwardly from the first rim 83 and second rim 85 away from the rotor axis R₁. In other embodiments, the blades 90, 92 extend radially inwards from the first rim 83 and second rim 85, toward the rotor axis R₁.

In some embodiments, the blades 90, 92 are similar to the blades 20, 30 described above, and operate in much the same manner. During operation in a wind field W, the first energy conversion portion 80 operates in much the same manner as the first energy conversion portion 12. The airflows of the wind field W interact with the blades 90 of the first rotor 82, causing the first rotor 82 to rotate in a first angular direction D1, while the wind field W interacts with the blades 92 of the second rotor 84, causing the second rotor 84 to rotate in a second angular direction D2 opposite the first angular direction D1. As above, the first rotor 82 drives the first main shaft 36 in the first direction D1, and the second rotor 84 drives the second main shaft 48 in the opposite direction D2. In this manner, this first energy conversion portion 80 can be used to drive the generator rotor 44 and stator 60 of the generator 34 in opposite directions.

In some embodiments, the first rim 83 of the first rotor 82 and the second rim 85 of the second rotor 84 can be made of a flat and circular metal or plastic ring type structure, to which the blades 90, 92 are affixed. The blades 90, 92 can be affixed in any number of suitable ways, such as by welding, bolting, mechanical interference fitting, fastening using adhesives or using other methods. In some embodiments, the rotors 82, 84 could be made of square or round tubing.

In some embodiments, the blades 90, 92 can be made of a pliable material, such as a rubber or plastic. In some embodiments, the blades 90, 92 could be made from flat or curved pieces of metal. In some embodiments the blades 90, 91 can be spring or rubber mounted in order to spill wind and avoid excessive rotational velocities.

In some embodiments, the spokes 86, 88 are made of square or round tubing. In other embodiments, the spokes 86, 88 could comprise steel cables.

In some embodiments, the operation of the first energy conversion portion 80 can be assisted by the use of a bag 94 that is attached to the outer periphery of the second rotor 84. The bag 94 is made of any suitably pliable material, such as a fabric, rubber or light plastic. The bag 94 operates as a wind stop, or enclosure, and tracks wind direction to keep the first energy conversion portion 80 and the turbine 10 generally aligned in the direction of airflows in a wind field W. The bag 94 also acts in a similar manner to the frusto-conical shape of the first rotor 18 described above, in that it forces the airflows to the outer portion of the rotors 82, 84 where a maximum amount of torque can be generated. The bag 94 also provides increased wind pressure and allows the rotors 82, 84 to start turning in reduced wind conditions.

For example, as shown in FIG. 9, an incoming wind field W is traveling in a generally parallel direction. However, once the wind field W encounters the bag 94, the air will be deflected up and back towards the blades 90, 92 of the rotors 82, 84. In some embodiments, the bag 94 is porous and allows some air to pass through it. In other embodiments, the bag 94 is impermeable, and no air can pass through.

In some embodiments, the blades 90, 92 extending radially outwards from the first rim 83 and second rim 85 of the rotors 82, 84 allows the airflows directed by the bag 94 to create a “bag blocking wind flow” that engages with the blades 90, 92 for increased efficiency.

It will be appreciated by those skilled in the art that the terms “first rotor” and “second rotor” as used throughout this document are interchangeable, and are not meant to be limiting. In some embodiments, the first rotor 18 will drive the armature 44, while in other embodiments the first rotor 18 will drive the stator 60. Similarly, in some embodiments the second rotor 28 will drive the stator 60 while in other embodiments the second rotor 28 will drive the armature 44.

Having thus described exemplary embodiments of the present invention, it should be noted by those skilled in the art that the within disclosures are exemplary only, and that various other alternatives, adaptations, and modifications may be made within the scope of the present invention. For example, the first rotor and second rotor may have non-frusto-conical configurations in which the outer surface diverges from a leading end to a trailing end. For example, in some embodiments the first rotor 18 and second rotor 28 can have a generally parabolic shape, for example a convex parabola or a concave parabola. Accordingly, the present invention is not limited to the specific embodiments illustrated herein, but is limited only by the following claims.

1. A wind turbine, comprising:
a generator to generate electricity and including a first rotatable power element and a second rotatable power element adapted for contra-rotation relative to one another about a generator axis;
a pair of rotors to convert wind energy into rotational energy and generally disposed at a first end of the generator and adapted for rotation about a rotor axis offset from the generator axis, and including a first rotor and a second rotor wherein the first rotor is disposed between the second rotor and the generator; and
a transmission to couple the pair of rotors to the generator, and including a first driveshaft coupled to the first rotor, a first drive element coupled to the first driveshaft, a first driven element coupled to the first drive element and to the first rotatable power element of the generator, a second driveshaft coupled to the second rotor and extending through the first driveshaft, a second drive element coupled to the second driveshaft, and a second driven element coupled to the second drive element and to the second rotatable power element of the generator.

2. The wind turbine of claim 1, wherein the first rotatable power element includes a field element and the second rotatable power element includes an armature.

3. The wind turbine of claim 1, wherein the first rotatable power element includes a stator and the second rotatable power element includes a rotor.

4. The wind turbine of claim 1, wherein the generator further includes:
a first end plate coupled to the first rotatable power element and to the first driven element;
a second end plate coupled to the first rotatable power element and having commutator rings thereon;
a generator shaft coupled to the second rotatable power element and to the second driven member, and extending through the first rotatable power element and the end plates; and
a pair of bearings supporting the generator shaft on opposite ends of the generator.

5. The wind turbine of claim 1, wherein the first rotor includes:
a first end having a first diameter;
a first annular array of blades generally disposed at the first end; and
a second end having a second diameter smaller in size than the first diameter.

6. The wind turbine of claim 5, wherein the second rotor includes:
a first end having a first diameter;
a second annular array of blades generally disposed at the first end; and
a second end having a second diameter smaller in size than the first diameter.

7. The wind turbine of claim 6, wherein the first and second rotors are generally cone-shaped and at least partially nested such that the second end of the second rotor is disposed between the first and second ends of the first rotor.

8. The wind turbine of claim 5, wherein the second rotor includes:
a rim having a diameter substantially corresponding to the first diameter of the first rotor;
a second annular array of blades generally disposed at the rim; and
an array of spokes coupled between the rim and the second driveshaft.

9. The wind turbine of claim 1, wherein the first rotor includes:
a first rim having a first diameter;
a first annular array of blades generally disposed at the first rim;
a first array of spokes coupled between the first rim and the first driveshaft; and wherein the second rotor includes:
a second rim having a second diameter;
a second annular array of blades generally disposed at the second rim; and
a second array of spokes coupled between the second rim and the second driveshaft.

10. The wind turbine of claim 1, wherein the first rotor includes a first annular array of blades disposed at a first angle and the second rotor includes a second annular array of blades disposed at a second angle different from the first angle.

11. The wind turbine of claim 10, wherein the first and second angles are opposite in direction to enable contra-rotation of the rotors.

12. The wind turbine of claim 11, wherein the first and second angles are equal in magnitude.

13. The wind turbine of claim 1, wherein the drive elements are drive gears and the driven elements are driven gears.

14. The wind turbine of claim 1, further comprising a first speed ratio defined by the first drive and driven elements and a second speed ratio defined by the second drive and driven elements, wherein the first speed ratio is between 4:1 and 30:1 and the second speed ratio is between 4:1 and 30:1.

15. The wind turbine of claim 13, wherein the first drive and driven gears are disposed on the first end of the generator and the second drive and driven gears are disposed on an oppositely disposed second end of the generator.

16. The wind turbine of claim 1, further comprising a support structure adapted to support the generator, and wherein the second driveshaft extends through a portion of the support structure.

17. A wind turbine, comprising a pair of rotors to convert wind energy into rotational energy and including a first rotor and a second rotor, wherein the first rotor includes a first end having a first diameter, a first annular array of blades generally disposed at the first end, a second end having a second diameter smaller in size than the first diameter, and a substantially circumferentially continuous web extending between the first and second ends to define a flow surface, and wherein the second rotor includes a second annular array of blades adjacent the first annular array of blades.

18. The wind turbine of claim 17, wherein the web is generally cone-shaped.

19. The wind turbine of claim 17, wherein the second rotor further includes a first end supporting the second annular array of blades and having a first diameter, and a second end having a second diameter smaller in size than the first diameter, and a second substantially circumferentially continuous web extending between the first and second ends of the second rotor, wherein the second rotor is at least partially nested within the first rotor such that the second end of the second rotor is disposed between the first and second ends of the first rotor.

20. A wind turbine, comprising a pair of rotors to convert wind energy into rotational energy and including a first rotor and a second rotor adjacent the first rotor, wherein the first rotor includes a first rim having a first annular array of blades, a first driveshaft, and a first array of spokes coupled between the first rim and the first driveshaft, and wherein the second rotor includes a second rim having a second annular array of blades, a second driveshaft extending through the first driveshaft, and a second array of spokes coupled between the second rim and the second driveshaft.

21. A generating apparatus for generating electrical energy from a wind field having a plurality of airflows, the apparatus comprising:
a first plurality of blades for engaging the airflows, the first plurality of blades being configured to rotate in a first angular direction about a first axis of rotation when exposed to the airflows;
a second plurality of blades for engaging the airflows, the second plurality of blades being configured to rotate in a second angular direction about a second axis of rotation when exposed to the airflows, the second angular direction being opposite the first angular direction;
at least one flow directing surface for directing the airflows i) outward from the first axis of rotation to engage the first plurality of blades, and ii) outward from the second axis of rotation to engage the second plurality of blades, wherein the at least one flow directing surface is configured relative to the first plurality of blades and the second plurality of blades such that during operation i) most of the airflows engaging the first plurality of blades are directed outwards by the at least one flow directing surface, and ii) most of the airflows engaging the second plurality of blades are directed outwards by the at least one flow directing surface;
a generator for generating electrical energy having an armature and a stator; and
a transmission coupled to the first plurality of blades and the second plurality of blades, and configured to drive the armature in a third angular direction and the stator in a fourth angular direction as the first plurality of blades turn in the first angular direction and the second plurality of blades turn in the second angular direction, the fourth angular direction being opposite the third angular direction,
wherein, as the armature rotates in the third direction and the stator rotates in the fourth direction, the generator generates electrical energy.

22. The apparatus as defined in claim 21 wherein the at least one flow directing surface comprises a first outer surface of a first rotor linking the first plurality of blades to the transmission.

23. The apparatus as defined in claim 22 further comprising a pivotal mount for pivoting the first rotor and the first plurality of blades, wherein the first outer surface of the first rotor is configured to generate, when exposed to the airflows, a drag force for pivoting the first rotor and the first plurality of blades such that the first outer surface of the first rotor is upwind of the first plurality of blades.

24. The apparatus of claim 22, further comprising a second rotor linking the second plurality of blades to the transmission, wherein the second rotor is offset from and at least partially nested within the first rotor.

25. The apparatus of claim 24, wherein the second rotor is coupled to the first rotor to pivot with the first rotor.

26. The apparatus of claim 24, wherein the first outer surface has a first frusto-conical shape defined by a first cone angle.

27. The apparatus of claim 26, wherein the second rotor has a second frusto-conical shape defined by a second cone angle.

28. The apparatus of claim 21, wherein each blade in the first plurality of blades is offset at a first angle from a first plane and each blade in the second plurality of blades is offset at a second angle from a second plane, the second angle being in the opposite direction as the first angle, wherein the first plane and second plane are generally parallel.

29. The apparatus of claim 28 wherein the first angle is substantially equal in magnitude to the second angle.

30. The apparatus of claim 24, wherein the transmission is coupled to the first rotor and the second rotor by a first shaft and a second shaft, wherein the first shaft is hollow and the second shaft passes through the first shaft.

31. The apparatus of claim 24, wherein the first plurality of blades extend radially from the first rotor and the second plurality of blades extend radially from the second rotor.

32. The apparatus of claim 24, wherein the first plurality of blades is located proximate an end of the first rotor and the second plurality of blades is located proximate an end of the second rotor.

33. The apparatus of claim 23, wherein the pivotal mount includes a support structure for disposing the first rotor and second rotor at a predetermined distance away from a ground structure, the pivotal mount being operable to facilitate pivoting of the first rotor and second rotor with respect to the ground surface.
